(19) United States
(12) Patent Application Publication
(10) Pub. No.: US 2015/0235140 A1
(43) Pub. Date: Aug. 20, 2015

(54) METHOD AND INFORMATION SYSTEM FOR DETERMINING A LANE CHANGE WHICH IS INTENDED OR NOT INTENDED BY THE DRIVER WHEN DRIVING A VEHICLE

(71) Applicant: ROBERT BOSCH GMBH, Stuttgart (DE)

(72) Inventor: Thomas Rothermel, Stuttgart (DE)

(21) Appl. No.: 14/426,682

(22) PCT Filed: Aug. 26, 2013
(86) PCT No.: PCT/EP2013/067629

§ 371 Date: Mar. 6, 2015

(30) Foreign Application Priority Data
Sep. 12, 2012 (DE) 10 2012 216 112.0

(51) Int. Cl. G06N 5/04

(52) U.S. Cl. CPC G06N 5/048

(57) ABSTRACT

A method for determining whether a lane change is intended by the driver of a vehicle includes: reading in at least one object acquired in front of the vehicle; assigning one of a plurality of possible risk values to the object, the risk value representing a potential risk of the object to the vehicle; recognizing a lane change carried out, or that is to be carried out, by the vehicle during travel; and evaluating the recognized lane change to determine whether the lane change is intended or not intended by the driver, the evaluation taking place taking into account the risk value assigned to the at least one object.

### BACKGROUND OF THE INVENTION

1. Field of the Invention

The present invention relates to a method for determining a lane change that is intended or not intended by the driver when driving a vehicle, to a corresponding information system, and to a corresponding computer program product.

2. Description of the Related Art

Because a large proportion of accidents result from unintentional departure from a lane on which a vehicle is traveling, systems have been developed, for example by Robert Bosch GmbH, that warn the driver of an unintentional lane departure, or that even actively intervene in the vehicle steering. Here, in most cases an intentional lane change is assumed when the driver actuates the turn signal before and during the lane departure. If the driver forgets to use the turn signal, for example after executing a passing maneuver and moving back into the lane, a false warning is issued. If these false alarms occur frequently, there is a danger that the driver will switch off the assistance system. Therefore, in order to achieve greater acceptance, it is desirable to be able to distinguish intentional lane changes from unintentional lane changes even without the assistance of the turn signal.

In order to solve this problem, in the dissertation of Matthias Henning, “Preparation for lane change maneuvers: Behavioural indicators and underlying cognitive processes,” Technische Universität Chemnitz (2010), the interior of the vehicle, and above all the driver, were observed, and an attempt was made to interpret typical behavior patterns preceding lane changes. It was discovered that, before an intentional lane change, the driver more frequently looks at the rear view mirror and side mirror. However, to discover this a special vehicle interior sensor system is necessary that monitors the driver's angle of view, which is associated with increased costs.

In further investigations, various data sources were analyzed in order to distinguish intentional lane changes from unintentional lane changes with the aid of typical signal curves. Here, the most effective predictive features turned out to be the lateral distance to the roadway marking at the warning time TLC=1s (1s before lane departure), the gas pedal position (TLC=1s), the change of gas pedal position (between TLC=1s and TLC=2s), and the difference between the minimum and maximum of the angle to the lane (between TLC=1s and TLC=4s). Through the evaluation of these features, a predictive quality of up to 85% was achieved.

Published German patent application document DE 10 2010 002 067 A1 discloses a driver assistance system for a motor vehicle having a lane guidance assistance function.

### BRIEF SUMMARY OF THE INVENTION

Against this background, the present invention presents a method for determining a change of lane that is intended or not intended by the driver while driving a vehicle, and in addition presents an information system that uses this method, as well as, finally, a corresponding computer program product.

The present invention creates a method for determining a lane change intended or not intended by the driver while driving a vehicle, the method having the following steps:
reading in of at least one acquired object situated in front of the vehicle;
assignment of one of a plurality of possible risk values to the at least one object, the risk value representing a potential risk to the vehicle of the at least one object;
recognition of a lane change carried out, or to be carried out, by the vehicle during travel; and
an evaluation of the recognized lane change as intended by the driver, the evaluation taking place on the basis of the risk value assigned to the at least one object, and/or evaluation of the recognized lane change as not intended by the driver, the evaluation taking place on the basis of the risk value assigned to the at least one object.

A lane change can be understood as a change of the lane in which the vehicle is driving on a roadway. An object can be understood for example as an obstacle or vehicle on a roadway, or a line or marking on or next to the roadway, situated in front of the vehicle. In addition, in the step of reading in a plurality of objects can also be read in that can be distinguished from one another. During the reading in, it is also possible to read in a geographical position and/or a relative spatial position of the at least one object, relative to the vehicle. Thus, the reading in can also be understood such that the read-in object or objects is/are read in as a map in which, alongside the object, the position of the object is also stored. In this way, for example a map can be populated with objects situated in the environment surrounding the vehicle. A risk value can be understood as a parameter that enables a subdivision of a risk potential into various risk classes that can be distinguished and that can be arranged in ordinal fashion (i.e. in a sequence). An evaluation can be understood as an assignment of an attribute to the recognized lane change, so that this lane change is interpreted as consciously introduced or executed by the driver, or that this lane change was caused by the driver of the vehicle unintentionally, or through inattention. In this evaluation, at least one risk value assigned to the at least one object is taken into account. In particular, the lane change can be evaluated as intended by the driver of the vehicle if the risk value assigned to the at least one object fulfills a specified first criterion. Alternatively or in addition, the lane change can be evaluated as not intended by the driver of the vehicle if the risk value assigned to the at least one object fulfills a specified second criterion. Such a (first or second) criterion can for example be that the risk value of the relevant object is greater than or less than a threshold value, or that a risk value of a first object is greater than or less than a risk value of a second object.

The present invention is based on the recognition that an evaluation (which can also be referred to as a classification) of the lane change as intended by the driver or not intended by the driver takes place, this evaluation being carried out as a function of a risk value assigned to an object in front of the vehicle. In this way, the fact can now be exploited that an intentional lane change will take place with a high probability and can be recognized if in fact an object in front of the vehicle has been recognized that presents a certain risk to the vehicle. On the other hand, a lane change can be evaluated as unintentional if no object has been recognized directly in front of the vehicle that presents a risk to the vehicle, but a lane change was nonetheless recognized. The present invention thus offers the advantage of a particularly simple and precise possibility of distinguishing between an intended and an unintended lane change, because the presence, or a type, of an object in front of the vehicle can be acquired very easily and reliably and used for the evaluation.

In addition, a specific embodiment of the present invention is advantageous in which, in the step of assignment, the object is classified in an object class, the object class being assigned one of a plurality of risk values. An object class can be understood for example as a class or group that makes the type of an object distinguishable. For example, objects can be classified in a first object class that represents obstacles, such as vehicles on the roadway in front of the home vehicle. Alternatively or in addition, a further object class can be provided in which an object is classified if it represents a roadway marking or line. Various object classes can also be subdivided, so that a distinction can be made between mobile versus immobile objects in front of the vehicle. The object classes can also have one or more subclasses. For example, an object class, in which objects are classified that represent a roadway marking or an object that can be reproduced in an image as a detectable line. One or more of the object classes can also each have a subclass in which the object is respectively classified if it represents either a dashed roadway marking, a solid roadway marking, or an obstacle that cannot be driven over. In an object class that can contain an object moving in front of the home vehicle or in front of a traveling non-home vehicle, a distinction can be made according to the relative speed of the moving object relative to the speed of the home vehicle. Here, in general it can be said that a risk value is higher the more negative the relative speed of the non-home vehicle is relative to the home vehicle (i.e., the faster the distance becomes smaller between the non-home vehicle and the home vehicle). In addition, it can be noted that risk values in different object classes can also be equal. In contrast, risk values from a common object class are different in order to enable a distinction between the objects in an object class. Such a specific embodiment of the present invention offers the advantage of a particularly detailed subdivision of the potential risk of an object to the vehicle, whereby a very high reliability can be achieved in distinguishing between an intended lane change and an unintended lane change.

According to a further specific embodiment of the present invention, in the step of assignment the risk value can be assigned to the object as a function of a relative speed of the object relative to the vehicle, in particular in the step of assignment the object being assigned a risk value representing a high risk if the object and the vehicle are approaching one another rapidly, or the object being assigned a risk value representing a low risk if the object and the vehicle are approaching one another slowly or are moving away from one another. Such a specific embodiment of the present invention offers the advantage of a particularly good possibility of distinguishing an intended lane change from an unintended lane change.

According to a further specific embodiment of the present invention, in the step of reading in, a lane object can be read in that is situated on a lane trajectory that the vehicle would traverse in the future if a lane change were not made, one of the plurality of possible risk values being assigned to the lane object in the step of assignment. A lane trajectory can be understood as a line (or at least a part of such a line) that follows the course of the lane on which the home vehicle is currently driving. A lane object can be understood as an object, or one of a plurality of objects, situated in front of the home vehicle on the lane trajectory. Such a specific embodiment of the present invention offers the advantage that for the evaluation of the lane change, an object is specifically used that is situated on a path that the vehicle would travel if it did not change lanes. The choice of such an object for distinguishing or evaluating the intended or unintended lane change can also make it possible to carry out a very precise discrimination with a low failure rate.

According to a further specific embodiment of the present invention, it is also particularly advantageous if, in the step of reading in, a vehicle trajectory object is read in that is situated on a vehicle trajectory that represents at least a partial segment of an actual future driving route of the vehicle, one of the plurality of possible risk values being assigned to the vehicle trajectory object in the step of assignment. Here, a vehicle trajectory can represent the actual travel path of the vehicle in the immediate future. This immediate future travel path of the vehicle can for example be determined from a set steering angle of the steering wheel, or from an evaluation of the position of the vehicle on the roadway using the positions of lane markings. Such a specific embodiment of the present invention offers the advantage that in the assessment of an intentional or unintentional lane change, the risk to the vehicle presented by an object on an actual travel path is taken into account. In this way, it is also possible to carry out a very precise and accurate discrimination between intended and unintended lane changes, with a low additional outlay.

In addition, according to a specific embodiment of the present invention the vehicle trajectory can be distinguished from the lane trajectory, so that for example through the deviation of the vehicle trajectory from the lane trajectory, on the one hand the existence of the lane change can be recognized, and/or on the other hand a speed of lane change can also be determined via a degree or magnitude of the deviation of the vehicle trajectory from the lane trajectory. In this way, a lane change of the vehicle can be recognized using means that are very easy to implement technically.

In addition, a specific embodiment of the present invention is advantageous in which, in the step of evaluation, the recognized lane change is evaluated as intended by the driver if the risk value assigned to the lane trajectory object stands in a specified relation to the risk value assigned to the vehicle trajectory object.

Such a specified relation can for example be a comparison as to which of the two risk values compared to one another is larger or smaller. Such a specific embodiment of the present invention offers the advantage that it can be set into a relation how great the risk is to the vehicle when the lane trajectory is followed versus how great the risk is to the vehicle when the vehicle trajectory is followed. In this way, taking into account a plurality of parameters, or the probable risk thereof to the vehicle, it can be determined whether the lane change is to be evaluated as intended by the driver or as unintended by the driver.

According to a further specific embodiment of the present invention, in the step of evaluation the recognized lane change can be evaluated as intended by the driver if the risk value assigned to the lane trajectory object represents a higher risk to the vehicle than the risk value assigned to the vehicle trajectory object. Such a specific embodiment of the present invention makes use of the fact that, given a greater risk in the home lane, the driver will intentionally move to an adjacent lane in order to reduce the risk to the vehicle. Such an evaluation of a lane change as intended by the driver offers the advantage that a machine-executed automatic evaluation of the lane change is now possible in a very concrete manner, based closely on reality, because it relies strongly on a human evaluation of the risk situation in the environment in front of the vehicle.

Alternatively or in addition, it is also conceivable that, according to a further specific embodiment of the present invention, in the step of evaluation the recognized lane change is evaluated as not intended by the driver if the risk value assigned to the lane trajectory object represents a lower or equally large risk to the vehicle than the risk value assigned to the vehicle trajectory object. Such a specific embodiment of the present invention offers the advantage that it can also be clearly recognized that a lane change is probably not intended by the driver. In this case, there is in addition a possibility of outputting a corresponding warning signal to the driver in order to give the driver the possibility of terminating the unintentionally introduced lane change. For example, such a warning signal can be outputted as an acoustic signal or as a haptic signal via the steering wheel.

Particularly advantageous is a specific embodiment of the present invention in which, in the step of reading in, a lane object is read in that is situated on a lane trajectory that has a lane trajectory length that is a function of a vehicle speed, and/or in the step of reading in a vehicle trajectory object is read in that is situated on a vehicle trajectory that has a vehicle trajectory length that is a function of a vehicle speed. Such a specific embodiment of the present invention offers the advantage that at high vehicle speeds even objects can be taken into account, on one or both of the named trajectories, that are situated at a large distance in front of the vehicle. In this way, increased vehicle safety can be realized, because at high vehicle speeds an object that could be dangerous to the vehicle can be recognized and taken into account at an early time for the evaluation of the lane change.

In order in addition to take into account a personal driving style of the driver, in particular during a lane change, in the evaluation of an actually recognized lane change, according to a further specific embodiment of the present invention in the step of reading in a risk parameter can additionally be read in that represents a risk tolerance on the part of the driver of the vehicle during a lane change, the recognized lane change being evaluated, in the step of evaluation, taking into account the risk parameter. Such a specific embodiment of the present invention offers the advantage that for example a warning to the driver can be omitted, or at least delayed, when a lane change is evaluated as not intended by the driver, if it is known to the algorithm for executing the evaluation step that the driver has a tendency to move out of the lane. In contrast, for example in the case of a very careful driver who seldom departs from the home lane, an evaluation of a given lane change can take place already in the case of significantly smaller signs of an unintentional lane change. This procedure makes it possible for an information system to output a warning of the occurrence of an unintentional lane change in a manner adapted to the specific driver.

The present invention also creates a control device or information system that is fashioned to carry out, control, or implement the steps of a variant of the method presented here in corresponding devices. The object of the present invention can also be achieved quickly and efficiently by this variant embodiment of the present invention in the form of a control device or information system.

In the present context, a control device or information system can be understood as an electrical device that processes sensor signals and outputs control and/or data signals as a function thereof. The control device or information system can have an interface that can be fashioned as hardware and/or as software. In the case of a hardware realization, the interfaces can for example be part of a so-called system ASIC that contains a wide range of functions of the control device or information system. However, it is also possible for the interfaces to be separate integrated circuits, or to be made up at least partly of discrete components. In the case of a realization in software, the interfaces can be software modules present for example on a microcontroller alongside other software modules.

Also advantageous is a computer program product having program code that can be stored on a machine-readable carrier such as a semiconductor memory, a hard drive memory, or an optical storage device, and used to carry out the method according to one of the above-described specific embodiments when the program product is executed on a computer or on a device.

In the following, the present invention is explained in more detail on the basis of the accompanying drawings.

### BRIEF DESCRIPTION OF THE DRAWINGS

FIG. 1 shows a block diagram of a vehicle having an information system according to an exemplary embodiment of the present invention.

FIG. 2 shows a representation of an example situation of a passing maneuver.

FIG. 3A through 3D show diagrams indicating examples of respective assignments of a risk value to objects in various situations according to exemplary embodiments of the present invention.

FIG. 4A through 4B show diagrams indicating example situations for the evaluation of risk values along different trajectories according to exemplary embodiments of the present invention.

FIG. 5 shows a flow diagram of a method according to an exemplary embodiment of the present invention.

### DETAILED DESCRIPTION OF THE INVENTION

In the following description of preferred exemplary embodiments of the present invention, identical or similar reference characters are used for elements shown in the various Figures and having similar functions, and repeated description of these elements is omitted.

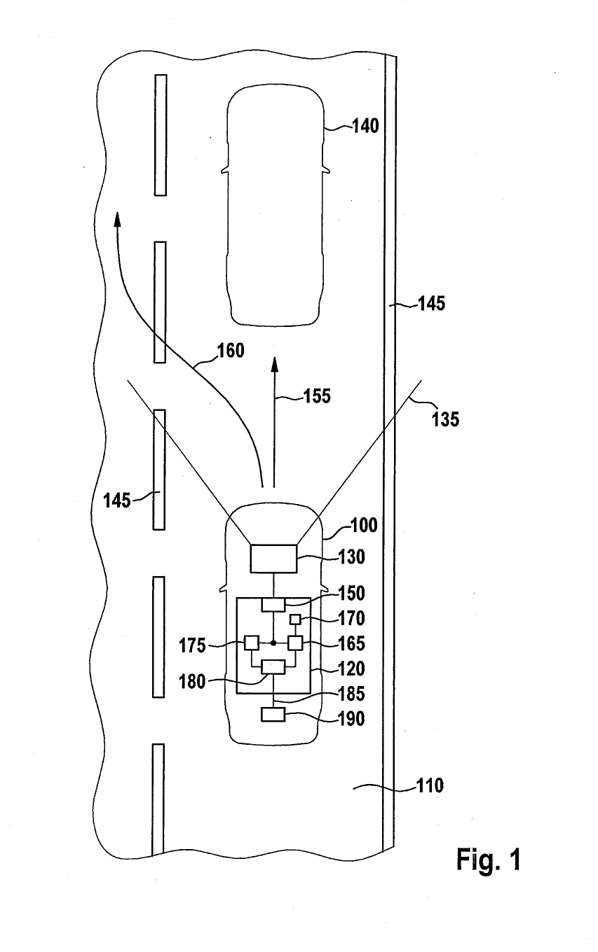

FIG. 1 shows a block diagram of a vehicle 100 traveling on a roadway 110 and equipped with an information system 120 according to an exemplary embodiment of the present invention. In addition, vehicle 100 has for example a camera 130 that is fashioned to acquire an area of acquisition 135 and objects situated therein, such as a non-home vehicle 140 traveling in front of vehicle 100, or roadway markings 145 on the right or left side of roadway 110. Here, a roadway marking 145 on the right side of vehicle 100 can be a continuous lane boundary line, and a roadway marking 145 on the left side of vehicle 100 can be a dashed (center) lane boundary line.

Camera 130 can in addition be fashioned to directly recognize objects acquired in area of acquisition 135, such as for example non-home vehicle 140 or one or more lines 145; i.e., to extract them from the image recorded by camera 130 and to provide them to information system 120 via an interface 150. In addition, camera 130 can for example be fashioned to determine a relative movement and/or a relative speed of non-home vehicle 140 relative to vehicle 100, and to provide this relative movement or relative speed to information system 120 as an attribute of an object recognized as non-home vehicle 140. In addition, camera 130 can also be fashioned to identify lines 145 for example as continuous or dashed, and to provide a corresponding indication to information system 120 also as an attribute of an object recognized as line 145. In addition, camera 130 can also be fashioned to determine a trajectory 155 of the course of the lane (also designated lane trajectory), for example on the basis of the course of lines 145, that maps the course of roadway 110 in front of vehicle 100. Camera 130 can also be fashioned for example to recognize a movement of vehicle 100 out of lane 110 (lane change), for example by evaluating the distances of lines 145 relative to vehicle 100, and in this way determining the position of vehicle 100 on lane 110. In this way, a trajectory 160 (vehicle trajectory) can be determined that describes a path that vehicle 100 is actually traveling or will travel in the immediate future. However, vehicle trajectory 160 can also, alternatively or in addition, be determined using one or more other physical quantities such as the evaluation of the steering angle. In addition, camera 130 can be fashioned to determine whether an object is situated at all on or in the area of lane trajectory 155, or which object, such as for example non-home vehicle 140, is so situated, and/or whether an object is situated at all in or on a region of vehicle trajectory 160, or which object, such as for example the line or roadway marking 145, is so situated. The information as to whether, or which, object is situated on lane trajectory 155, and/or whether, or which, object is situated on vehicle trajectory 160 can also be communicated to information system 120 via interface 150.

In information system 120, the information read in via interface 150 can then on the one hand be transmitted to an assignment unit 165, in which one of a plurality of possible risk values is assigned to an object according to an assignment rule whose form is to be described in more detail. Here, for example an assignment table can be read out from a storage device 170 in which it is stored which object, object type, and/or which object property is to be assigned which defined risk value. As a result, from assignment unit 165 an object signal can be obtained that includes an item of information concerning which risk value is to be assigned to a recognized object.

In addition, in a recognition unit 175 it can be recognized that the vehicle is currently executing a change of lane 110, or will change lanes in the immediate future. This can for example take place through evaluation of the curve of vehicle trajectory 160, it being recognized that for example the vehicle has crossed one of the lines 145. As a result, from recognition unit 175 a lane change signal can thus be obtained that contains an item of information indicating that a lane change has taken place or will soon take place.

The object signal, and the lane change signal, are subsequently read in by an evaluation unit 180 in which it is determined, taking into account at least one risk value assigned to the object and according to a procedure described in more detail below, whether the recognized lane change is intended by the driver or not. As a result, evaluation unit 180 can provide an evaluation signal 185 that is for example evaluated by a warning unit 190, and in the case of a lane change evaluated as not intended by the driver, for example outputs a corresponding warning message to the driver of vehicle 100. This warning message can for example be an optical signal in the visual field of the driver, an acoustic signal, for example using an infotainment system of the vehicle, or a haptic signal at the steering wheel, in order to inform the driver about the lane change recognized as not intended. If a lane change recognized as intended by the driver has been determined, in contrast an output of such a warning message can be omitted so that a driver of vehicle 100 is not unnecessarily distracted from paying attention to traffic.

The approach presented here thus enables a traffic situation-based recognition of the driver's intention in the case of lane change maneuvers. In the approaches known in the existing art, the driver's behavior is analyzed directly via observation of the vehicle interior, or indirectly via typical signal curves, and an attempt is made to draw inferences therefrom about the driver's intention. In both cases, however, the situation in the environment surrounding the vehicle is not examined. Thus, in addition to the line data, in most cases object data are also available, with associated information such as type, position, size, and relative speed, from which typical driving characteristics of the driver can also be derived.

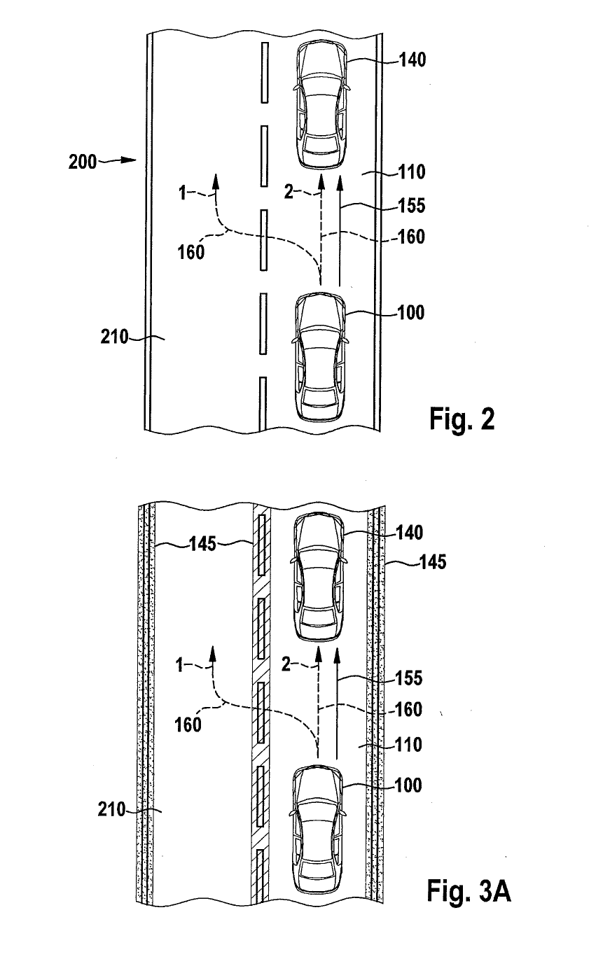

In order to illustrate a particular example situation, in FIG. 2 a diagram is shown of a possible passing maneuver. If home vehicle 100 is for example traveling in the right lane 110 of a two-lane highway 200, approaching another vehicle 140 (non-home vehicle) with a high relative speed, and if left lane 210 is open, it can be assumed that a lane departure to the left is intended in order to pass the vehicle in front (situation for travel path 1, i.e. vehicle trajectory 160 follows path 1). However, if non-home vehicle 140 is traveling faster than home vehicle 100 (for example after passing and returning to the lane), a passing maneuver of home vehicle 100, and thus the desired lane change, is improbable (situation for travel path 2, i.e. vehicle trajectory 160 follows path 2). In this way, if-then rules can be formulated that describe the respective situation. From these rules, for example fuzzy inference methods can then be used to draw inferences concerning the probability of an intentional lane change. Due to the number of possible situations, particular care is to be taken that all cases are covered by rules, and that this very large system of rules is evaluated in each calculation step.

In order to adequately explain this aspect of the lane change, first the behavior of the driver is examined in somewhat more detail. The following theses can be asserted, now used in part for the evaluation of the recognized lane change:
The driver will maneuver the vehicle in the direction in which he estimates there to be the lowest risk of a collision.
Both other vehicles and also lane markings and boundaries, such as walls, are perceived as risks.
Not all recognized risks are evaluated as equally dangerous by the driver. Thus, for example a lane marking over which it is possible to drive presents a lower risk than a guard rail or another vehicle.
Objects having a small distance from the home vehicle are more dangerous.
Objects having higher relative speeds are more dangerous than objects having low relative speeds.
In the case of higher speed of the home vehicle, the driver should look further ahead.

The current traffic situation is then evaluated by the driver, while driving, for example at least partly from the above-named points of view. The driver will then make a decision for or against a lane change.

According to an exemplary embodiment of the present invention, a similar procedure is followed: first, based on the recognized object or the recognized line, or the plurality of recognized objects and/or lines, a kind of map is produced. Subsequently, risk potentials are assigned to this object or objects and/or line or lines, as a function of various criteria. These criteria are defined for example as in the following Table 1:

TABLE 1

| Type of obstacle | Object property | Risk potential |
|---|---|---|
| Line | Dashed | Low |
| | Solid | High |
| | Obstacle that cannot be driven over | Very high |
| Object | High negative relative speed | Very high |
| | Medium negative relative speed | High |
| | Relative speed close to zero | Low |
| | Positive relative speed | None |

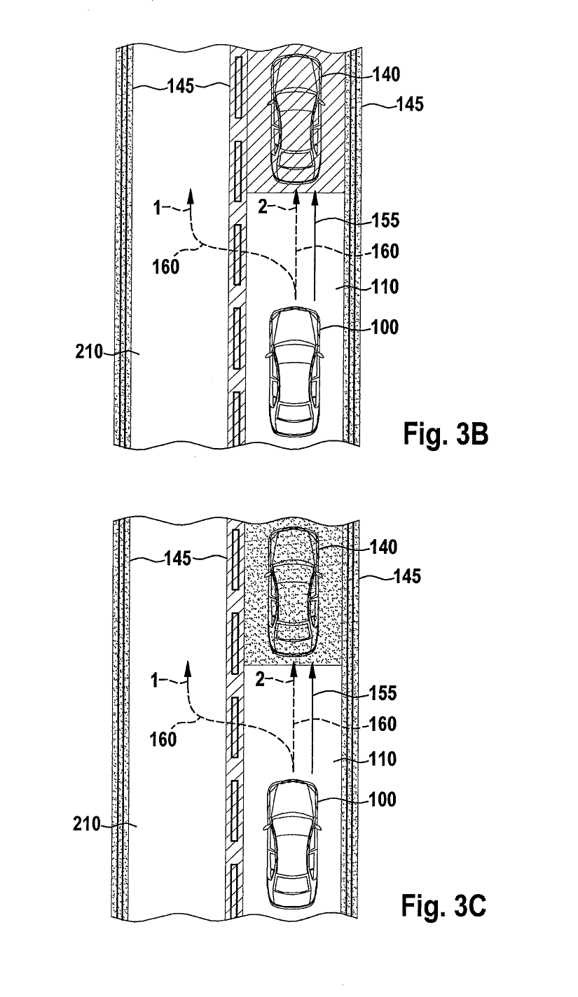

Here the risk potential can be understood as the risk value, which can assume different values, it being possible to order these values in a sequence. Thus, for example a risk value for risk potential “low” can have a lower value than a risk value representing risk potential “high.” In this way, a risk potential map can be created in which the objects and lines are listed with their degrees of risk. Such a map is shown for the situation named in the introductory example, in FIGS. 3A through 3D.

FIGS. 3A through 3D show risk potential maps or diagrams that indicate examples of assignments of a risk value to objects in various situations according to exemplary embodiments of the present invention.

FIG. 3A shows a situation in which the relative speed of vehicle 100 relative to vehicle traveling in front 140 is positive (i.e., vehicle traveling in front 140 is moving away from home vehicle 100), and therefore the situation does not have any risk potential for vehicle 100. The danger originating from vehicle in front 140 can therefore be evaluated as low. The risk to vehicle 100 that originates from center line 145 when this line is crossed, considering it as an object, can also be regarded as low, resulting in the identification of center line 145 as an object having a low risk value. For this reason, in FIG. 3A center line 145 is situated in a region identified by hatching, which represents a low risk to vehicle 100. In contrast, roadway boundary lines 145 at the lateral edge of roadway 110 represent a significantly greater risk to vehicle 100, because if these roadway boundary lines 145 are crossed, there is a danger of leaving roadway 110, so that an accident resulting in personal injury could easily occur.

In the case of a relative speed close to zero relative to home vehicle 100, as shown in the situation according to FIG. 3B, the danger originating from non-home vehicle as object 140 is evaluated as low, so that the object is also shown situated in a region with oblique hatching.

FIG. 3C shows a situation in which a medium negative speed of non-home vehicle 140 traveling in front relative to home vehicle 100 is shown. Here, in comparison with the situation shown in FIG. 3B a risk value is assigned to non-home vehicle 140 that is at least one grade higher, symbolically represented by a dotted region around non-home vehicle 140 in FIG. 3C.

FIG. 3D shows a situation in which non-home vehicle traveling in front 140 has a high negative relative speed relative to home vehicle 100. In this situation, non-home vehicle 140 is assigned a still higher risk value compared to the situation shown in FIG. 3C, symbolically represented by a region having vertical hatching around non-home vehicle 140 in FIG. 3D.

In order now to calculate or evaluate whether it is safer to stay in the lane or to maintain the vehicle course specified by the driver, for example via the steering wheel angle, resulting in a lane change, according to an exemplary embodiment of the present invention two trajectories are calculated:
A first trajectory is determined from the course of the lane (lane trajectory 155): in order to calculate the overall risk potential for the case in which the vehicle stays in the lane, based on the available lane curvature and change of lane curvature a trajectory is calculated that follows the current lane course.
A second trajectory is for example determined from the steering angle (vehicle trajectory 160): in order to calculate the overall risk potential for the course specified by the driver, from the steering wheel angle, using the steering mechanism translation ratio, a trajectory is calculated that corresponds to the true vehicle course.

The lengths of trajectories 155 and 160 can for example also be a function of speed, so that given increasing speeds an increasingly longer respective trajectory 155 or 160 is determined in order to achieve a longer look-ahead. Subsequently, the two calculated trajectories are laid over the risk potential map (or it is determined whether an acquired object is situated on one of the trajectories 155, 160), in order in each case to determine or to calculate the overall risk potentials along trajectories 155, 160. It can now be assumed that the driver intends to steer the vehicle where the risk is lowest.

In order to calculate the probability of an intended lane departure, according to the exemplary embodiment presented here the two calculated overall risk potentials are thus placed into relation to one another. At the time of the lane departure warning, this probability is used, with the aid of a deactivation limit, for a possible deactivation of the warning message. Here it is also conceivable to cause an activation or deactivation of the lane departure warning to be carried out without the calculation of a probability, but rather to infer an intended or unintended lane departure directly from the comparison of the risk values of the objects, and to output or suppress a corresponding warning.

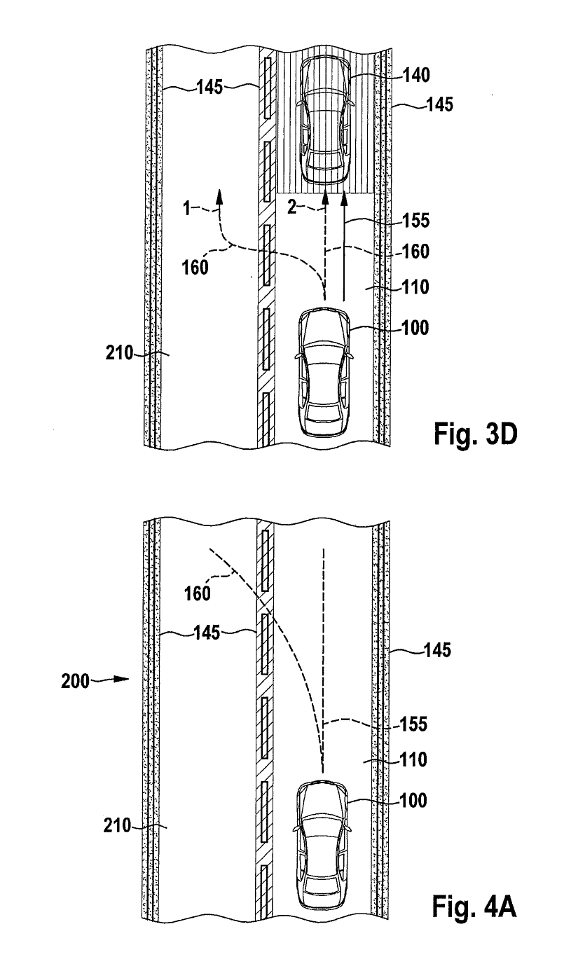

To illustrate the evaluation of the risk potentials along the trajectories, two example situations are shown in FIGS. 4A and 4B. In FIGS. 4A and 4B, example situations are shown for the evaluation of the risk potentials along the trajectories. In a situation according to the representation shown in FIG. 4A, travel on an open two-lane highway 200 is shown. Because no object having an assigned risk value, and thus no risk potential, is situated on lane trajectory 155, there is no danger in staying in the lane. There is thus no reason to change lanes. If vehicle course trajectory 160, for example calculated from the steering angle, intersects with dashed roadway marking 145, this marking is assigned a low risk potential. The driver of the vehicle should therefore be warned in this case.

In a situation according to the representation of FIG. 4B, in contrast, a vehicle 100 is approaching a non-home vehicle traveling in front 140 with a large negative relative speed. Thus, lane trajectory 155 now has a high risk potential (i.e., an object on this lane trajectory has a high risk value), and vehicle trajectory 160 has a low risk potential (i.e., an object on this vehicle trajectory 160 has a low risk value). Because the lane change appears less dangerous than staying in the lane, an intentional lane change is assumed. Via the deactivation boundary for the outputting of a warning signal, the information system shown here can be adjusted to the risk tolerance of the current driver of vehicle 100.

A further advantage is that this determined probability or evaluation of the lane change can also be used in combination with other characteristic quantities or already existing methods for recognizing driver intention.

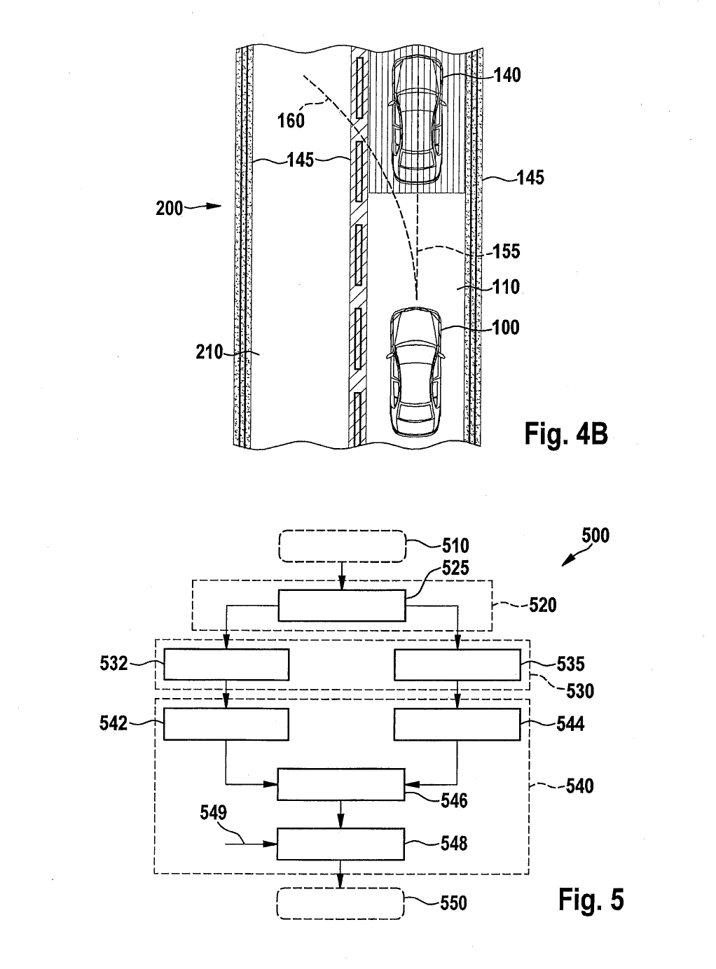

An overview of an exemplary embodiment of the approach proposed here is shown in FIG. 5 in the form of a flow diagram. In FIG. 5, a flow diagram is shown of an exemplary embodiment of a method 500 according to the present invention for determining a lane change intended or not intended by the driver when driving a vehicle. Method 500 includes a step of reading in 510 of at least one object acquired in front of the vehicle, where this object can represent a line or data about an obstacle. In addition, method 500 includes a step of assignment 520 of one of a plurality of possible risk values to the object, the risk value representing a potential risk that the object presents to the vehicle. In the step of assignment 520, a substep can also be provided of creation 525 of a risk potential map in which for one or more objects, in addition to the information that an object is present at all, information can also be present concerning a location of the object relative to the vehicle, and, via the risk value, information can also be present concerning the risk to the vehicle originating from the object. In addition, method 500 includes a step of recognition 530 of a lane change carried out, or that is to be carried out, by the vehicle during travel. This step of recognition 530 can for example include a substep of calculation 532 of a vehicle trajectory, for example from the steering angle. The step of recognition 530 can also contain a further substep of calculation 535 of a lane trajectory. Finally, method 500 includes a step of evaluation 540 of the recognized lane change as intended by the driver, the evaluation 540 taking place taking into account the risk value assigned to the at least one object, and/or an evaluation 540 takes place of the recognized lane change as not intended by the driver, this evaluation 540 taking place taking into account the risk value assigned to the at least one object. In particular, according to an exemplary embodiment of the present invention, in the step of evaluation 540 a substep of calculation 542 of the risk potential along or on the vehicle trajectory can be provided, i.e. it can be determined whether an object is situated on the vehicle trajectory and which risk value is assigned to this object. In addition, the step of evaluation 540 can also include a substep of calculation 544 of the risk potential along the lane trajectory, i.e. it can be determined whether an object is situated on the lane trajectory and which risk value is assigned to this object. From the risk potential of the vehicle trajectory, or the risk value of the at least one object on the vehicle trajectory, and/or the risk potential of the lane trajectory or the risk value of the at least one object on the lane trajectory, a probability can then be determined, for example in a substep 546, of a lane departure intended by the driver. In the case of a decision as to whether the lane departure was actually intended by the driver, in a decision step 548 in addition an item of information can be taken into account concerning a risk tolerance 549 of the driver of the vehicle before, as a result of method 500, an item of information 550 is obtained according to which the recognized lane departure was intended by the driver or not intended by the driver. In response to this information 550, a warning can then for example be outputted to the driver if the lane departure has been evaluated as not intended.

According to a particular exemplary embodiment, in the approach proposed here a method is understood for detecting an intention to change lanes on the part of a driver of a motor vehicle 100 that has a step of determining a map of risk potentials in the surrounding environment of motor vehicle 100. In addition, this method includes a step of determination of a first trajectory 160, which describes a future travel path of motor vehicle 100. The method also includes a step of determination of a first risk potential as a function of first trajectory 160 and of the map. In addition, such a method includes a step of determining a second trajectory 155, which describes a course of the one roadway 110 on which motor vehicle 100 is situated. Such a method also includes a step of determination of a second risk potential as a function of second trajectory 155 and of the map. Finally, such a method includes a step of determination of a probability for the lane change intention as a function of the first and second risk potential.

A high degree of flexibility of the method proposed here is possible through the (active) distribution of the risk potentials. Thus, for example the risk map can be constructed according to other criteria if the home vehicle is in the passing lane during a passing maneuver, or if traffic sign recognition has indicated a ban on passing. For other components as well, such as the Forward Collision Warning system, information about the situation-specific driver intention recognition can be made available and used.

The exemplary embodiments described and shown in the Figures have been chosen only as examples. Different exemplary embodiments can be combined with one another completely or with regard to individual features. An exemplary embodiment can also be supplemented by features of a further exemplary embodiment.

In addition, method steps according to the present invention can be repeated, and can be executed in a different sequence than the one described.

If an exemplary embodiment includes an “and/or” linkage between a first feature and a second feature, this is to be read as meaning that according to one specific embodiment the exemplary embodiment has both the first feature and the second feature, and according to a further specific embodiment the exemplary embodiment has either only the first feature or only the second feature.

1-12. (canceled)

13. A method for determining whether a lane change is intended or not intended by a driver while driving a vehicle, comprising:
reading in at least one object detected in front of the vehicle;
assigning one of a plurality of possible risk values to the object, the assigned risk value representing a potential risk of the object to the vehicle;
recognizing a lane change carried out by the vehicle during travel; and
evaluating the recognized lane change to determine whether the lane change is one of intended by the driver or not intended by the driver, the evaluation taking into account the risk value assigned to the at least one object.

14. The method as recited in claim 13, wherein in the step of assigning the risk value, the object is classified as being in a selected one of a plurality of object classes, and wherein one of a plurality of risk values is assigned to the selected object class.

15. The method as recited in claim 14, wherein in the step of assigning the risk value, the risk value is assigned to the object as a function of a relative speed of the object relative to the vehicle such that the assigned risk value is increased as the relative approaching speed between the object and the vehicle increases.

16. A method as recited in claim 15, wherein in the step of reading in, a lane trajectory object is read in which is situated on a lane trajectory which the vehicle would traverse in the future without a lane change.

17. The method as recited in claim 16, wherein in the step of reading in, a vehicle trajectory object situated on a vehicle trajectory of the vehicle is read in, the vehicle trajectory representing at least one partial segment of a future travel route of the vehicle, and wherein one of the plurality of possible risk values is assigned to the vehicle trajectory object in the step of assignment.

18. The method as recited in claim 17, wherein in the step of evaluation, the recognized lane change is evaluated as intended by the driver if the risk value assigned to the lane trajectory object stands in a specified relation to the risk value assigned to the vehicle trajectory object.

19. The method as recited in claim 18, wherein in the step of evaluation, the recognized lane change is evaluated as intended by the driver if the risk value assigned to the lane trajectory object represents a higher risk to the vehicle than the risk value assigned to the vehicle trajectory object.

20. The method as recited in claim 18, wherein in the step of evaluation, the recognized lane change is evaluated as not intended by the driver if the risk value assigned to the lane trajectory object is no greater than the risk value assigned to the vehicle trajectory object.

21. The method as recited in claim 20, wherein at least one of:
the lane trajectory object is situated on a lane trajectory having a lane trajectory length which is a function of a speed of the vehicle; and
the vehicle trajectory object is situated on a vehicle trajectory having a vehicle trajectory length which is a function of a speed of the vehicle.

22. The method as recited in claim 18, wherein:
in the step of reading in, a risk parameter is additionally read in which represents a risk tolerance of the driver of the vehicle during a lane change process; and
in the step of evaluation, the recognized lane change is evaluated taking into account the risk parameter.

23. An information system, comprising:
a control including a processor configured to perform the following:
reading in at least one object detected in front of the vehicle;
assigning one of a plurality of possible risk values to the object, the assigned risk value representing a potential risk of the object to the vehicle;
recognizing a lane change carried out by the vehicle during travel; and
evaluating the recognized lane change to determine whether the lane change is one of intended by the driver or not intended by the driver, the evaluation taking into account the risk value assigned to the at least one object.

24. A non-transitory, computer-readable data storage medium storing a computer program having program codes which, when executed on a computer, perform a method for determining whether a lane change is intended or not intended by a driver while driving a vehicle, the method comprising:
reading in at least one object detected in front of the vehicle;
assigning one of a plurality of possible risk values to the object, the assigned risk value representing a potential risk of the object to the vehicle;
recognizing a lane change carried out by the vehicle during travel; and
evaluating the recognized lane change to determine whether the lane change is one of intended by the driver or not intended by the driver, the evaluation taking into account the risk value assigned to the at least one object.
